(19) United States
(12) Patent Application Publication
(10) Pub. No.: US 2026/0162972 A1
(43) Pub. Date: Jun. 11, 2026

(54) ALL SOLID STATE BATTERY

(71) Applicants: HYUNDAI MOTOR COMPANY, Seoul (KR); KIA CORPORATION, Seoul (KR); IUCF-HYU (Industry-University Cooperation Foundation Hanyang University), Seoul (KR)

(72) Inventors: Ki Yoon Bae, Hwaseong-si (KR); Sang Heon Lee, Hwaseong-si (KR); Sam Ick Son, Hwaseong-si (KR); Ji Young Kim, Hwaseong-si (KR); Kyu Seok Kim, Seoul (KR); Da Young Jun, Seoul (KR); Yun Jung Lee, Seoul (KR)

(73) Assignees: HYUNDAI MOTOR COMPANY, Seoul (KR); KIA CORPORATION, Seoul (KR); IUCF-HYU (Industry-University Cooperation Foundation Hanyang University), Seoul (KR)

(21) Appl. No.: 19/181,852

(22) Filed: Apr. 17, 2025

(30) Foreign Application Priority Data
Dec. 2, 2024 (KR) 10-2024-0176883

(51) Int. Cl. H01M 4/36; H01M 4/02; H01M 4/62; H01M 4/66; H01M 10/0562

(52) U.S. Cl. CPC H01M 4/366; H01M 4/625; H01M 4/661; H01M 10/0562; H01M 2004/021; H01M 2004/028

(57) ABSTRACT

An all solid state battery includes a cathode current collector, a cathode active material layer disposed on the cathode current collector, and including a cathode active material, a solid electrolyte layer disposed on the cathode active material layer, an anode disposed on the solid electrolyte layer, and a sacrificial cathode layer including a sacrificial active material, and disposed between the cathode current collector and the cathode active material layer.

### CROSS-REFERENCE TO RELATED APPLICATION

This application claims the benefit of priority to Korean Patent Application No. 10-2024-0176883, filed in the Korean Intellectual Property Office on Dec. 2, 2024, the entire contents of which are incorporated herein by reference.

### TECHNICAL FIELD

The present disclosure relates to an all solid state battery and a method for manufacturing the same, and more particularly, relates to an all solid state battery including a sacrificial cathode layer and a method for manufacturing the same.

### BACKGROUND

A secondary battery, which is rechargeable, has been used in smaller electronic devices, such as a mobile phone or a laptop computer, as well as in larger transportation applications, such as hybrid and electric vehicles. Accordingly, these expanding applications creates a need to develop a secondary battery having higher stability and an improved energy density.

For a conventional secondary battery, a cell is mainly based on an organic solvent (or an organic liquid electrolyte). Accordingly, conventional secondary battery technology has limited improvement potential with regard to stability and an energy density. In contrast, an all solid state battery typically employs an inorganic solid electrolyte and does not require an organic solvent. Accordingly, all solid state battery technology has received substantial attention, as it provides for the manufacture of a cell in a more stable and simpler form.

Generally, a typical all solid state battery includes a cathode active material layer bonded to a cathode current collector, an anode active material layer bonded to an anode current collector, and a solid electrolyte layer interposed between the anode active material layer and the cathode active material layer. However, the anode active material layer includes a solid electrolyte for moving lithium ions in addition to the anode active material, such as graphite, and the solid electrolyte has a specific gravity higher than a specific gravity of a liquid electrolyte. Accordingly, the energy density of the state of the art all solid state battery is lower than an energy density of a lithium ion battery using liquid electrolyte.

Recently, efforts to increase the energy density of the all solid state battery have been directed to an anodeless all solid state battery in a storage type that directly precipitates lithium ions on the anode current collector in the form of lithium metal, without the anode active material layer. However, when the anodeless all solid state battery is charged, lithium transmitted from the cathode is plated on the anode current collector and forms a lithium dendritic crystal. The charging/discharging efficiency may be reduced due to the irreversible increase of the capacity, which results from the growth of the lithium dendritic crystal in the anodeless all solid state battery.

To solve the above problem, conventionally, a sacrificial cathode material, which additionally provides a lithium source to serve as an additive, is added into the cathode active material layer to compensate for the irreversible capacity issue. However, when the sacrificial cathode material, which serves as the additive, is added into the cathode active material layer, the decomposition reaction can form an air gap in the cathode, thereby causing a characteristic unstable lifespan. As such, it remains difficult to add a sufficient amount of the sacrificial cathode material to compensate for the irreversible capacity problem.

### SUMMARY

The present disclosure addresses the above-mentioned problems associated with the prior art while also maintaining certain advantages that have been achieved.

An aspect of the present disclosure provides an all solid state battery, capable of adding a sacrificial cathode material in an amount sufficient (i) to suppress one or more side reactions that result from the decomposition of the sacrificial cathode material and/or (ii) to compensate for said problem, and a method for manufacturing the same.

The technical problems addressed by the present disclosure are not limited to the aforementioned problems. The disclosure may provide solutions to other technical problems not mentioned herein specifically, which will be clearly understood by those skilled in the art to which the present disclosure pertains from the following description of aspects and embodiments.

(1) In an aspect, the present disclosure provides an all solid state battery which includes a cathode current collector, a cathode active material layer disposed on the cathode current collector, and including a cathode active material, a solid electrolyte layer disposed on the cathode active material layer, an anode disposed on the solid electrolyte layer, and a sacrificial cathode layer including a sacrificial active material, and disposed between the cathode current collector and the cathode active material layer.

(2) In some embodiments, the present disclosure provides an all solid state battery in which the sacrificial active material is included in content ranging from 5 wt % to 20 wt %, based on a total weight of the cathode active material included in the cathode active material layer, in exemplary aspect (1) and related embodiments.

(3) In some embodiments, the present disclosure provides an all solid state battery in which the sacrificial cathode layer has ion conductivity ranging from 7.5×10⁻⁶ S/cm to 7.5×10⁻⁴ S/cm, in exemplary aspects and embodiments (1) or (2).

(4) In some embodiments, the present disclosure provides an all solid state battery in which the sacrificial cathode layer has electron conductivity ranging from 9.6×10⁻⁶ S/cm to 9.6×10⁻³ S/cm, in any one of exemplary aspects and embodiments (1) to (3).

(5) In some embodiments, the present disclosure provides an all solid state battery in which the sacrificial cathode layer has a charging capacity ranging from 800 mAh/g to 1,200 mAh/g, in any one of exemplary aspects and embodiments (1) to (4).

(6) In some embodiments, the present disclosure provides an all solid state battery in which the sacrificial active material has oxidation-reduction potential lower than a discharge voltage of the cathode active material, in any one of exemplary aspects and embodiments (1) to (5).

(7) In some embodiments, the present disclosure provides an all solid state battery in which the sacrificial cathode layer further includes a conductive material, a solid electrolyte, and a binder, and, based on a total weight of the sacrificial cathode layer, the sacrificial active material is included in content ranging from 50 wt % to 70 wt %, the conductive material is included in content ranging from 5 wt % to 15 wt %, the solid electrolyte is included in content ranging from 20 wt % to 35 wt %, and the binder is included in content ranging from 0.5 wt % to 5 wt %, in any one of exemplary aspects and embodiments (1) to (6).

(8) In some embodiments, the present disclosure provides an all solid state battery in which the conductive material included in the sacrificial cathode layer is a carbon-based material, in any one of exemplary aspects and embodiments (1) to (7).

(9) In some embodiments, the present disclosure provides an all solid state battery in which the sacrificial cathode layer has a thickness ranging from 5 [symbol] to 40 [symbol] , in any one of exemplary aspects and embodiments (1) to (8).

(10) In some embodiments, the present disclosure provides an all solid state battery in which an average crystal size of the sacrificial active material calculated through Equation 1 ranges from 40 nm to 50 nm.

$${D}_{p} = \frac{0.94 \times λ}{β \times Cos θ} , \qquad Equation 1$$

in which, in Equation 1, Dp is an average crystal size of the sacrificial active material, λ is a wavelength of an X ray used in XRD analysis of the sacrificial active material, θ is a Bragg angle of a main peak observed in the XRD analysis of the sacrificial active material, and β is a full width at half maximum (FWMH) of a main peak observed in the XRD analysis of the sacrificial active material.

(11) In some embodiments, the present disclosure provides an all solid state battery in which the solid electrolyte layer includes a sulfide-based solid electrolyte, in any one of exemplary aspects and embodiments (1) to (10).

(12) In some embodiments, the present disclosure provides an all solid state battery in which the anode includes an intermediate layer disposed on the solid electrolyte layer, and an anode current collector disposed on the intermediate layer, in any one of exemplary aspects and embodiments (1) to (11).

(13) In some embodiments, the present disclosure provides an all solid state battery in which the anode current collector includes at least one selected from the group consisting of nickel (Ni), copper (Cu), stainless steel (SUS), silver (Ag), and a combination of nickel (Ni), copper (Cu), stainless steel (SUS), or silver (Ag), in any one of exemplary aspects and embodiments (1) to (12).

(14) In some embodiments, the present disclosure provides an all solid state battery in which the intermediate layer includes metal particles for forming an alloy with lithium, in any one of exemplary aspects and embodiments (1) to (13).

(15) In another aspect, the disclosure provides for methods for manufacturing an all solid state battery in accordance with any one or more the aspects and embodiments of the disclosure.

### BRIEF DESCRIPTION OF THE DRAWINGS

The above aspects and embodiments, as well as other objects, features, and advantages of the present disclosure will be more apparent from the following detailed description taken in conjunction with the accompanying illustrative drawings:

FIG. 1 depicts a schematic view illustrating the general structure of an all solid state battery, according to an embodiment of the present disclosure;

FIG. 2 depicts a graph illustrating a resistance, which is measured through Electrochemical Impedance Spectroscopy, of each of a half-cell manufactured in accordance with the description in Reference example 1 according to the present disclosure after the half-cell is first charged;

FIG. 3 depicts a graph illustrating a resistance, which is measured through Electrochemical Impedance Spectroscopy, of a half-cell manufactured in accordance with the description in Reference example 2 according to the present disclosure after the half-cell is first charged;

FIG. 4 depicts a graph illustrating a resistance, which is measured through Electrochemical Impedance Spectroscopy, of a half-cell manufactured in accordance with the description in Reference example 3 according to the present disclosure after a half-cell is first charged;

FIG. 5 depicts a view illustrating images obtained by analyzing the structure of a cross-section of an all solid state battery, which is manufactured in accordance with the description in Embodiment 1 of the present disclosure, through SEM-FIB and EDX;

FIG. 6 depicts a graph representing the relation between a voltage and an areal capacity of an all solid state battery manufactured in accordance with the description in Embodiment 1 of the present disclosure and Comparative example 1;

FIG. 7 depicts a view obtained by enlarging a portion of a graph representing the relation between a voltage and a specific capacity measured when each of all solid state batteries in accordance with Embodiment 1 of the present disclosure, Comparative example 1, and Comparative example 2 is discharged;

FIG. 8 depicts a graph representing the relation between a voltage and a specific capacity of each of all solid state batteries in accordance with Embodiment 1 of the present disclosure, Comparative example 1, and Comparative example 2; and

FIG. 9 depicts a graph representing a specific capacity measured for each cycle of each of all solid state batteries manufactured in accordance with the description in Embodiment 1 and Comparative examples 1 and 2.

### DETAILED DESCRIPTION

Hereinafter, the present disclosure will be described in more detail for the understanding of the present disclosure.

Unless defined otherwise by the disclosure, all technical and scientific terms used herein should be given their ordinary and customary meaning as commonly understood by one of ordinary skill in the art to which the disclosure belongs. A number of terms and abbreviations appear throughout the disclosure and, unless otherwise defined or indicated, should be understood to have their reasonably broad commonly understood and plain meanings that are consistent with the context in which the terms are used.

As used herein, referent terms such as “first,” “second,” “initial,” “subsequent,” and the like, may be used for describing various components, but the components are not limited by the terms. These terms are only used to distinguish one component from another component. For example, without departing from the scope of the present disclosure, a first component may be named as a second component, and similarly, a second component may be named as a first component.

The terms used herein are used for describing particular embodiments only and are not intended to limit the present disclosure. A singular expression includes a plural expression unless otherwise defined differently in a context. In the present disclosure, it should be understood that term “comprising” or “having” or “including” (or comprises, has, or includes) indicates that a feature, a number, a step, an operation, a component, a part or a combination thereof described in the specification is present, but does not exclude a possibility of the presence or addition of one or more other features, numbers, steps, operations, components, parts or combinations thereof, in advance. It will be appreciated that those terms are also inclusive of the term “consisting of” or “consisting essentially of” which, when used throughout the disclosure or claims, generally indicate that a feature, a number, a step, an operation, a component, a part or a combination thereof described in the specification is present, and does not include any additional feature(s).

In a general sense, the present disclosure provides an all solid state battery comprising features and components that provide for one or more functional improvements to state of the art solid state battery technology.

According to an embodiment of the present disclosure, the all solid state battery includes a cathode current collector, a cathode active material layer disposed on the cathode current collector, and including a cathode active material, a solid electrolyte layer disposed on the cathode active material layer, an anode disposed on the solid electrolyte layer; and a sacrificial cathode layer including a sacrificial active material, and interposed between the cathode current collector and the cathode active material layer.

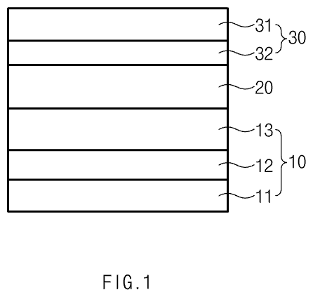

Hereinafter, components of the all solid state battery according to an embodiment of the present disclosure will be described with reference to FIG. 1 in detail. FIG. 1 is a view schematically illustrating a structure of the all solid state battery according to an embodiment of the present disclosure.

### Cathode

According to an embodiment of the present disclosure, the all solid state battery may include a cathode 10.

According to an embodiment of the present disclosure, the cathode 10 may include a cathode current collector 11, a cathode active material layer 13 disposed on the cathode current collector 11, and a sacrificial cathode layer 12 disposed between the cathode current collector 11 and the cathode active material layer 13.

According to an embodiment of the present disclosure, the cathode current collector 11 include various materials and is not particularly limited, as long as the materials have conductivity without inducing a chemical change in a relevant battery (the all solid state battery according to the present disclosure). For example, the cathode current collector 11 may comprise at least one of aluminum (Al), nickel (Ni), titanium (Ti), tungsten (W), iron (Fe), chromium (Cr), and/or stainless steel, or an alloy thereof. In some embodiments, the cathode current collector 11 may be selected from the group consisting of aluminum (Al), nickel (Ni), titanium (Ti), tungsten (W), iron (Fe), chromium (Cr), stainless steel, and an alloy thereof.

According to an embodiment of the present disclosure, the cathode active material layer 13 may include a cathode active material, a conductive material, and a binder.

According to an embodiment of the present disclosure, the cathode active material, which allows lithium ions (Lit) to be reversibly plated or released, may include a composite oxide (i.e., a lithium composite metal oxide) of lithium and metal. In some specific embodiments, the lithium composite metal oxide may be a lithium-manganese-based oxide (e.g., LiMnO₂ or LiMn₂O₄), a lithium-cobalt-based oxide (e.g., LiCoO₂), a lithium-nickel-based oxide (e.g., LiNiO₂), a lithium-nickel-manganese-based oxide (e.g., LiNi_{1-Y}Mn_{y}O₂ (0<Y<1), or LiMn_{2-z}Ni_{z}O₄ (0<Z<2)), a lithium-nickel-cobalt-based oxide (e.g., LiNi_{1-Y1}Co_{Y1}O₂ (0<Y1<1)), a lithium-manganese-cobalt-based oxide (e.g., LiCO_{1-Y2}Mn_{Y2}O₂ (0<Y2<1), or LiMn_{2-z1}CO_{z1}O₄ (0<Z1<2)), a lithium-nickel-manganese-cobalt-based oxide (e.g., Li(NiₚCo_{q}Mnᵣ₁)O₂ (0<p<1, 0<q<1, 0<r1<1, and p+q+r1=1) or Li(Niₚ₁Co_{q1}Mnᵣ₂)O₄ (0<p1<2, 0<q1<2, 0<r2<2, and p1+q1+r2=2)), or a lithium-nickel-cobalt-transition metal (M) oxide (e.g., Li(Niₚ₂CO_{q2}Mnᵣ₃M_{S2})O₂ (‘M’ is selected from the group consisting of Al, Fe, V, Cr, Ti, Ta, Mg, and Mo; p2, q2, r3 and s2 are atomic fractions of independent elements; 0<p2<1, 0<q2<1, 0<r3<1, 0<s2<1, and p2+q2+r3+s2=1)), or may include any one of the above materials or a compound including at least two of the above materials.

In some further embodiments, the lithium composite metal oxide may be LiCoO₂, LiMnO₂, LiNiO₂, a lithium nickel manganese cobalt oxide (e.g., Li(Ni_{1/3}Mn_{1/3}CO_{1/3})O₂, Li(Ni_{0.6}Mn_{0.2}Co_{0.2})O₂, Li(Ni_{0.5}Mn_{0.3}Co_{0.2})O₂, Li(Ni_{0.7}Mn_{0.15}Co_{0.15})O₂ and Li(Ni_{0.8}Mn_{0.1}Co_{0.1})O₂), or a lithium nickel cobalt aluminum oxide (e.g., Li(Ni_{0.8}Co_{0.15}Al_{0.05})O₂) that can enhance a capacity characteristic and the stability of a battery. In some particular embodiments that can exhibit one or more improved performance characteristics by controlling the type and content ratio of components forming the lithium composite metal oxide, the lithium nickel manganese oxide may be Li(Ni_{0.6}Mn_{0.2}CO_{0.2})O₂, cobalt Li(Ni_{0.5}Mn_{0.3}Co_{0.2})O₂, Li(Ni_{0.7}Mn_{0.15}Co_{0.15})O₂, and Li(Ni_{0.8}Mn_{0.1}CO_{0.1})O₂, or may employ any one of the above materials, or a mixture of at least two of the above materials.

According to an embodiment of the present disclosure, the cathode active material may include boron (B) or LiNbO, and may further include a coating layer surrounding the lithium composite metal oxide. In embodiments wherein the coating layer is further included, the structural stability of the cathode active material may be improved.

According to a further embodiment of the present disclosure, the cathode active material layer 13 may further include a solid electrolyte. The solid electrolyte may coat the cathode active material. Accordingly, the interfacial compatibility between the cathode active material layer 13 and a solid electrolyte layer 20 (as described hereinbelow) may be improved. The solid electrolyte in accordance with these embodiments are described throughout the description with reference to the solid electrolyte layer 20.

According to an embodiment of the present disclosure, the conductive material may further improve the conductivity of the cathode active material. The conductive material may include various materials and is not particularly limited, as long as the materials have conductivity without inducing a chemical change in the relevant battery. For example, the conductive material may include graphite; a carbon-based material, such as carbon black, acetylene black, ketjen black, channel black, furnace black, lamp black, thermal black, and SC65; a conductive fiber such as a carbon fiber or a metal fiber; metal powders such as carbon fluoride, aluminum or nickel powders; conductive whisker such as zinc oxide or potassium titanate; conductive metal oxide such as titanium oxide; and/or a conductive material, such as a polyphenylene derivative.

According to an embodiment of the present disclosure, the binder may facilitate the bonding among the conductive material, the cathode active material, and the cathode current collector. The binder may be polyvinylidene fluoride, polyvinyl alcohol, carboxymethylcellulose, starch, hydroxypropylcellulose, regenerated cellulose, polyvinylpyrrolidone, tetrafluoroethylene, polyethylene, polypropylene, ethylene-propylene-diene monomer, sulfonated ethylene-propylene-diene monomer, styrene-butadiene rubber, nitrile-butadiene rubber, fluorine rubber, and/or various copolymers thereof.

According to an embodiment of the present disclosure, the all solid state battery includes the sacrificial cathode layer 12 interposed between the cathode current collector 11 and the cathode active material layer 13. The sacrificial cathode layer 12, which comprises a separate layer including a sacrificial active material, may prevent the capacity of the all solid state battery from being reduced.

In general, the all solid state battery may generate a side reaction that consumes lithium ions on an interface between the solid electrolyte layer and the anode (in some specific embodiments, the anode current collector) during the charging and discharging process. When the lithium ions that participate in the side reaction are not compensated (e.g., replaced or supplemented), an amount of lithium ions used in the charging and discharging process is reduced. Accordingly, the capacity of the all solid state battery is reduced. Conventionally, a sacrificial active material serving as an additive is added into the cathode active material layer to compensate for the irreversible consumption of the lithium ions. However, in this conventional arrangement, the stability in structure of the cathode active material layer is deteriorated by an air gap that is produced, as the sacrificial cathode material is decomposed. Accordingly, using conventional technology, the sacrificial active material may not be applied into the cathode active material layer, in an amount (e.g., at least 5 wt % of the total weight of the cathode active material layer included in the cathode active material layer 13) sufficient to compensate for the irreversible consumption of the lithium ions. In contrast to this, and according to the present disclosure, as the sacrificial cathode layer 12 including the sacrificial active material is interposed between the cathode current collector 11 and the cathode active material layer 13, the issue related to the air gap may be resolved, reduced and/or slowed, and the sacrificial active material may be applied in content sufficient to compensate for the irreversible consumption of the lithium ions. Accordingly, the capacity of the all solid state battery as described herein may be improved.

In embodiments wherein the sacrificial cathode layer 12 is interposed between the cathode active material layer 13 and the solid electrolyte layer 20, the ion conductivity may be decreased due to the air gap and the decomposition residues produced after the sacrificial active material is decomposed, thereby significantly increasing a battery resistance.

According to an embodiment of the present disclosure, the sacrificial cathode layer 12 may include a sacrificial active material, a conductive material, a binder, and a solid electrolyte.

According to an embodiment of the present disclosure, the sacrificial active material included in the sacrificial cathode layer 12 has ion conductivity and electron conductivity. In an initial charging process, the sacrificial active material is decomposed into lithium ions and gas, and the decomposed lithium ions may complement (i.e., address, replace, mitigate, or supplement) for the irreversible consumption of the lithium ions described above.

According to an embodiment of the present disclosure, the sacrificial active material may include a lithium-containing compound having oxidation-reduction potential lower than a discharge voltage of the cathode active material. In some embodiments, the sacrificial active material may include at least one of Li₃N, Li₂O, Li₃P, Li₂S, Li₂CO₃, LiNO₃, Li₂C₂O₄ and LiAl (the alloy of Li and Al). In some specific embodiments, the sacrificial active material may be Li₃P.

According to an embodiment of the present disclosure, the sacrificial active material may be included in the sacrificial cathode layer 12, in content ranging from 50 wt % to 70 wt %, based on the total weight of the sacrificial cathode layer 12. Specifically, the sacrificial active material may be included in content of at least 51 wt %, at least 52 wt %, at least 53 wt %, at least 54 wt %, or at least 55 wt %, or at most 69 wt %, at most 68 wt %, at most 67 wt %, at most 66 wt %, or at most 65 wt %. in embodiments wherein the above range is satisfied, the conductivity of the sacrificial active material may be improved.

According to an embodiment of the present disclosure, the sacrificial active material may be included in the cathode active material layer 13, in content ranging from 5 wt % to 12 wt %, based on the total weight of the sacrificial cathode layer 12. In some specific embodiments, the sacrificial active material may be included in content of at least 5.5 wt %, at least 6 wt %, at least 6.5 wt %, at least 7 wt %, or at least 7.5 wt %, or at most 11.5 wt %, at most 11 wt %, at most 10.5 wt, at most 10 wt %, or at most 9.5 wt %. In embodiments wherein the above range is satisfied, lithium ions may be provided in an amount sufficient to compensate for the lithium ions that may otherwise be irreversibly consumed.

According to an embodiment of the present disclosure, the average crystal size of the sacrificial active material may range from 40 nm to 50 nm. In some specific embodiments, the average crystal size of the sacrificial active material may be at least 41 nm, at least 42 nm, at least 43 nm, or at least 44 nm, or at most 49 nm, at most 48 nm, at most 47 nm, or at most 46 nm. In embodiments wherein the above range is satisfied, the compensation for the irreversible consumption of the lithium ions may be more easily performed.

In some embodiments, the average crystal size of the sacrificial active material may be calculated through the following Equation 1.

$${D}_{p} = \frac{0.94 \times λ}{β \times Cos θ} \qquad Equation 1$$

In Equation 1,
Dₚ is the average crystal size of the sacrificial active material,
λ is a wavelength of an X ray used in an XRD analysis of the sacrificial active material,
θ is a Bragg angle of a main peak observed in the XRD analysis of the sacrificial active material, and
β is a full width at half maximum (FWMH) of a main peak observed in the XRD analysis of the sacrificial active material. Such numbers and ways for determining them are known by those of skill in the art, and some of which are described below.

According to the present disclosure, the main peak refers to a peak, which has the greatest strength (e.g., highest amplitude, highest value), among peaks observed in the XRD analysis.

According to an embodiment of the present disclosure, the average crystal size of the sacrificial active material may be determined by further performing a sintering process for the mixture of the sacrificial active material and the conductive material at the temperature ranging from 500° C. to 700° C., in the manufacturing process.

According to an embodiment of the present disclosure, the conductive material included in the sacrificial cathode layer 12 may further improve the conductivity of the sacrificial active material. For example, the conductive material may include graphite; a carbon-based material, such as carbon black, acetylene black, ketjen black, channel black, furnace black, lamp black, thermal black, and SC65; a conductive fiber such as a carbon fiber or a metal fiber; metal powders such as carbon fluoride, aluminum or nickel powders; conductive whisker such as a zinc oxide or potassium titanate; conductive metal oxide such as titanium oxide; and/or a conductive material, such as a polyphenylene derivative.

According to an embodiment of the present disclosure, the conductive material may be included in the sacrificial cathode layer 12, in content ranging from 5 wt % to 15 wt %, based on the total weight of the sacrificial cathode layer 12. In specific embodiments, the conductive material may be included in content of at least 5.5 wt %, at least 6 wt %, at least 6.5 wt %, at least 7 wt %, or at least 7.5 wt %, or at most 14 wt %, at most 13 wt %, at most 12 wt %, at most 11 wt %, or at most 10 wt %. In embodiments wherein the above range is satisfied, the conductivity of the sacrificial active material may be improved.

According to an embodiment of the present disclosure, the binder included in the sacrificial cathode layer 12 may facilitate the bonding among the conductive material, the sacrificial active material, and the solid electrolyte. The binder may be polyvinylidene fluoride, polyvinyl alcohol, carboxymethylcellulose, starch, hydroxypropylcellulose, regenerated cellulose, polyvinylpyrrolidone, tetrafluoroethylene, polyethylene, polypropylene, ethylene-propylene-diene monomer, sulfonated ethylene-propylene-diene monomer, styrene-butadiene rubber, nitrile-butadiene rubber, fluorine rubber, and various copolymers thereof.

According to an embodiment of the present disclosure, the binder may be included in the sacrificial cathode layer 12, in content ranging from 0.5 wt % to 5 wt %, based on the total weight of the sacrificial cathode layer 12. In specific embodiments, the binder may be included in content of at least 0.8 wt %, at least 1 wt %, at least 1.4 wt %, at least 1.8 wt %, or at least 2 wt %, or at most 4.8 wt %, at most 4.6 wt %, at most 4.4 wt %, at most 4.2 wt %, or at most 4 wt %. In embodiments wherein the above range is satisfied, the bonding among the conductive material, the sacrificial active material, and the solid electrolyte may be more easily performed.

According to an embodiment of the present disclosure, the solid electrolyte included in the sacrificial cathode layer 12 may improve the ion conductivity of the sacrificial cathode layer 12. The details of the solid electrolyte will be described in the following description discussing the solid electrolyte layer 20.

According to an embodiment of the present disclosure, the solid electrolyte may be included in the sacrificial cathode layer 12, in content ranging from 20 wt % to 35 wt, based on the total weight of the sacrificial cathode layer 12. in specific embodiments, the solid electrolyte may be included in content of at least 21 wt %, at least 22 wt %, at least 23 wt %, at least 24 wt %, or at least 25 wt %, or at most 34 wt %, at most 33 wt %, at most 32 wt %, at most 31 wt %, or at most 30 wt %. In embodiments wherein the above range is satisfied, the ion conductivity of the sacrificial cathode layer 12 may be more improved.

According to an embodiment of the present disclosure, the sacrificial cathode layer 12 may have a thickness ranging from 15 [symbol] to 25 [symbol] . Specifically, the sacrificial cathode layer 12 may have the thickness of at least 15.5 [symbol] , at least 16 [symbol] , at least 16.5 [symbol] , at least 17 [symbol] , or at least 17.5 [symbol] , or may be at most 24.5 [symbol] , at most 24 [symbol] , at most 23.5 [symbol] , at most 23 [symbol] , or 22.5 [symbol] . In embodiments wherein the above range is satisfied, a sufficient amount of lithium ions may be provided to compensate for the irreversible consumption of the lithium ions.

According to an embodiment of the present disclosure, the ion conductivity of the sacrificial cathode layer 12 may range from 7.5×10⁻⁶ S/cm to 7.5×10⁻⁴ S/cm. Specifically, the ion conductivity of the sacrificial cathode layer 12 may be at least 8.0×10⁻⁶ S/cm, at least 8.5×10⁻⁶ S/cm, at least 9.0×10⁻⁶ S/cm, at least 9.5×10⁻⁶ S/cm, or at least 1.0×10⁻⁵ S/cm, or at most 7.0×10⁻⁴ S/cm, at most 6.5×10⁻⁴ S/cm, at most 6.0×10⁻⁴ S/cm, at most 5.5×10⁻⁴ S/cm, or at most 5.0×10⁻⁴ S/cm. In embodiments wherein the above range is satisfied, the sacrificial active material included in the sacrificial cathode layer 12 may be effectively decomposed, so the lithium ions may be easily conserved.

According to an embodiment of the present disclosure, the electron conductivity of the sacrificial cathode layer 12 may range from 9.6×10⁻⁶ S/cm to 9.6×10⁻³ S/cm. In specific embodiments, the electron conductivity of the sacrificial cathode layer 12 may at least 9.8×10⁻⁶ S/cm, at least 1.0×10⁻⁵ S/cm, at least 1.5×10⁻⁵ S/cm, at least 2.0×10⁻⁵ S/cm, at least 4.0×10⁻⁵ S/cm, or at most 9.0×10⁻³ S/cm, at most 8.0×10⁻³ S/cm, at most 6.0×10⁻³ S/cm, at most 4.0×10⁻³ S/cm, or at most 1.0×10⁻⁴ S/cm. In embodiments wherein the above range is satisfied, the sacrificial cathode layer 12 may effectively transfer electrons to the cathode active material layer 13.

According to an embodiment of the present disclosure, the sacrificial cathode layer 12 may have a charging capacity ranging from 800 mAh/g to 1,200 mAh/g. In specific embodiments, the sacrificial cathode layer 12 may have the charging capacity of at least 820 mAh/g, at least 840 mAh/g, at least 860 mAh/g, at least 880 mAh/g, or at least 900 mAh/g, or at most 1,180 mAh/g, at most 1,160 mAh/g, at most 1,140 mAh/g, at most 1,120 mAh/g, or at most 1, 100 mAh/g. In embodiments wherein the above range is satisfied, the energy density of the all solid state battery may be effectively improved.

### Solid Electrolyte Layer

According to an embodiment of the present disclosure, the all solid state battery may include the solid electrolyte layer 20. The solid electrolyte layer 20 may be interposed between the cathode 10 and an anode 30 to transfer lithium ions which are present between the cathode 10 and the anode 30.

According to an embodiment of the present disclosure, the solid electrolyte layer 20 may be disposed on the cathode active material layer 13, and may include a solid electrolyte having lithium ion conductivity. The solid electrolyte include at least one of an oxide-based solid electrolyte, a sulfide-based solid electrolyte, a polymer electrolyte, or a combination thereof, and in some preferred embodiments may include the sulfide-based solid electrolyte.

According to an embodiment of the present disclosure, the sulfide-based solid electrolyte may include at least one of Li₆PS₅X (X=at least one of Cl, Br and I), Li₁₀GeP₂S₁₂, Li₃PS₄, Li₇P₃S₁₁, Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂SSiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (in which ‘m’ and ‘n’ is positive numbers; Z is one of Ge, Zn, and Ga), Li₂S-GeS₂, Li₂S—SiS₂—Li₃PO₄, Li₂S—SiS₂-LiₓMO_{y} (in which ‘x’ and ‘y’ are positive numbers; M is one of P, Si, Ge, B, Al, Ga, and In), and/or a combination thereof.

### Anode

According to an embodiment of the present disclosure, the all solid state battery may include the anode 30. The anode 30 may be disposed on the solid electrolyte layer 20, and may include an anode current collector 31 and an intermediate layer 32.

According to an embodiment of the present disclosure, the intermediate layer 32 may be disposed on the solid electrolyte layer 20, and the anode current collector 31 may be disposed on the intermediate layer 32.

According to an embodiment of the present disclosure, the anode current collector 31, which serves as a plate-shaped substrate having electrical conductivity, may include a material which does not react with lithium. In some specific embodiments, the anode current collector 31 include various materials and is not particularly limited, as long as the materials have conductivity without inducing a chemical change in the relevant battery. In some specific embodiments, the anode current collector 10 may be at least one of aluminum (Al), nickel (Ni), titanium (Ti), tungsten (W), iron (Fe), chromium (Cr), and/or stainless steel, or the alloy thereof.

According to an embodiment of the present disclosure, the intermediate layer 32, which is a component coated on the anode current collector 31, may readily react with the lithium ions to form the alloy and to induce deposition of lithium metal oriented in a horizontal direction along the surface of the anode current collector 31, when the lithium ions are precipitated in the form of lithium metal on the surface of the anode current collector 10.

According to an embodiment of the present disclosure, the intermediate layer 32 may include a metal for forming an alloy with lithium. In some specific embodiments, the intermediate layer 32 may include beryllium (Be), magnesium (Mg), aluminum (Al), silicon (Si), calcium (Ca), scandium (Sc), chromium (Cr), manganese (Mn), iron (Fe), cobalt (Co), nickel (Ni), copper (Cu), zinc (Zn), gallium (Ga), germanium (Ge), arsenic (As), strontium (Sr), yttrium (Y), zirconium (Zr), niobium (Nb), molybdenum (Mo), technetium (Tc), rhodium (Rh), palladium (Pd), silver (Ag), cadmium (Cd), indium (In), tin (Sn), antimon (Sb), tellurium (Te), barium (Ba), hafnium (Hf), tantalum (Ta), tungsten (W), rhenium (Re), iridium (Ir), platinum (Pt), gold (Au), mercury (Hg), thallium (TI), phosphorus (Pb), or bismuth (Bi), and/or a combination thereof.

According to an embodiment of the present disclosure, the intermediate layer 32 may have the thickness ranging from 100 nm to 1,000 nm. In embodiments wherein the above range is satisfied, the interface between the intermediate layer 32 and the solid electrolyte layer 20 may be uniformly formed, and the lithium metal may be easily deposited in the horizontal direction along the surface of the anode current collector 31.

According to an embodiment of the present disclosure, the intermediate layer 32 may be formed on the anode current collector 31 by performing a sputtering process with respect to metal for forming an alloy with lithium.

According to an embodiment of the present disclosure, the intermediate layer 32 may include an anode active material layer including anode active material.

According to another embodiment of the present disclosure, the anode active material is not particularly limited and, for example, may include a carbon active material and a metal active material.

According to another embodiment of the present disclosure, the carbon active material may be graphite, such as mesocarbon microbeads (MCMB) and highly oriented graphite (HOPG), or amorphous carbon such as hard carbon, and soft carbon.

According to another embodiment of the present disclosure, the metal active material may be In, Al, Si, Sn, Ag, Zn, and an alloy containing at least one element of In, Al, Si, Sn, Ag, or Zn.

Hereinafter, exemplary embodiments of the present disclosure will be described in detail such that those skilled in the art may easily understand and reproduce embodiments in accordance with the present disclosure. However, it will be appreciated that the present disclosure may be implemented in various forms, and is limited to embodiments described herein.

### Example 1

### 1) Forming of Solid Electrolyte Layer

90 mg of solid electrolyte powders including Li₆PS₅Cl_{0.5}Br_{0.5} was put into a mold having an inner diameter of 10 mm, and compressed at 200 MPa, thereby forming the solid electrolyte layer.

### 2) Forming of Cathode Active Material Layer

20 mg of powders of a cathode active material (LiNi_{0.8}Co_{0.1}Mn_{0.1}O₂), a solid electrolyte (Li₆PS₅Cl_{0.5}Br_{0.5}) and a binder (VGCF), which were mixed with each other at a ratio of 70:30:3 were put into a mold and compressed at 200 MPa, thereby forming a cathode active material layer on one surface of the solid electrolyte layer formed in 1).

### 3) Forming of Sacrificial Cathode Layer.

0.1 g of red Phosphorus (“red P”) (Sigma Aldrich) serving as a phosphorous precursor and 0.025 g of SC65 (TIMCAL) as a conductive material were introduced into a reactor, and a high energy ball milling (HEBM) process was performed at 300 RPM for 20 hours to prepare red P-SC65 composite powders. 1.61 g of lithium biphenyl (Sigma Aldrich) dissolved in THE solution was added to the prepared red P-SC65 composite powders to prepare Li₃P-SC65 composite powders. The prepared Li₃P-SC65 composite powders were fired at 600° C. for 4 hours to prepare crystallized Li₃P-SC65 composite powders. Thereafter, 1.68 mg of the crystallized Li₃P-SC65 composite powders, 0.67 mg of the solid electrolyte (Li₆PS₅Cl_{0.5}Br_{0.5}) powders, and 0.04 mg of the binder (NBR) powders were matched against one surface of the cathode active material layer formed in 2) and compressed at 380 MPa to form the sacrificial cathode layer.

### 4) Manufacturing of Anode

After preparing a cathode current collector having the thickness of 10 μm and including SUS316, a silver (Ag) thin film was formed on the surface of the cathode current collector through the DC sputtering process to manufacture a cathode. When manufacturing the cathode, 10 W, 20 W, 30 W, and 50 W were applied as sputtering power. The manufactured cathode was matched against an opposite surface of the solid electrolyte layer formed in 1) and compressed at 380 MPa.

### 5) Manufacturing of Cathode Current Collector

After preparing the cathode current collector having the thickness of 10 [symbol] and including Al, the cathode current collector was matched against one surface of the sacrificial cathode layer formed in 3), and compressed at 380 MPa to form the cathode current collector, thereby manufacturing the all solid state battery.

### Comparative Example 1

The all solid state battery was manufactured in the same manner as for Example 1, except for omitting the sacrificial cathode layer.

### Comparative Example 2

### 1) Forming of Solid Electrolyte Layer

90 mg of solid electrolyte powders including Li₆PS₅Cl_{0.5}Br_{0.5} was put into a mold having an inner diameter of 10 mm, and compressed at 200 MPa, thereby forming the solid electrolyte layer.

### 2) Forming of Anode Active Material Layer

21.4 mg of powders of a cathode active material (LiNi_{0.8}Co_{0.1}Mn_{0.1}O₂), a solid electrolyte (Li₆PS₅Cl_{0.5}Br_{0.5}), a binder (VGCF), and a sacrificial active material (Li₃P) which were mixed with each other at a ratio of 70:30:3:7 were put into a mold and compressed at 200 MPa, thereby forming the cathode active material layer on one surface of the solid electrolyte layer formed in 1).

### 3) Manufacturing of Anode

After preparing a cathode current collector having the thickness of 10 μm and including SUS316, a silver (Ag) thin film was formed on the surface of the anode current collector through the DC sputtering process to manufacture the anode. When manufacturing the anode, 10 W, 20 W, 30 W, and 50 W were applied as sputtering power. The manufactured anode was matched against an opposite surface of the solid electrolyte layer formed in 1) and compressed at 380 MPa.

### 4) Manufacturing of Cathode Current Collector

After preparing the cathode current collector having the thickness of 10 [symbol] and including Al, the cathode current collector was matched against one surface of the cathode active material layer formed in 2), and compressed at 380 MPa to form the cathode current collector, thereby manufacturing the all solid state battery.

### Reference Example 1

### 1) Forming of Solid Electrolyte Layer

90 mg of solid electrolyte powders including Li₆PS₅Cl_{0.5}Br_{0.5} was put into a mold having an inner diameter of 10 mm, and compressed at 200 MPa, thereby forming the solid electrolyte layer.

### 2) Forming of Cathode Active Material Layer

20 mg of powders of a cathode active material (LiNi_{0.8}Co_{0.1}Mn_{0.1}O₂), a solid electrolyte (Li₆PS₅Cl_{0.5}Br_{0.5}), and a binder (VGCF) which were mixed with each other at a ratio of 70:30:3 were put into a mold and compressed at 200 MPa, thereby forming the cathode active material layer on one surface the solid electrolyte layer formed in 1).

### 3) Manufacturing of Anode

The Li metal foil punched at 9 pi was matched against an opposite surface of the solid electrolyte layer formed in 1) and compressed at 380 MPa.

### Reference Example 2

### 1) Forming of Solid Electrolyte Layer

90 mg of solid electrolyte powders including Li₆PS₅Cl_{0.5}Br_{0.5} was put into a mold having an inner diameter of 10 mm, and compressed at 200 MPa, thereby forming the solid electrolyte layer.

### 2) Forming of Cathode Active Material Layer

20 mg of powders of a cathode active material (LiNi_{0.8}Co_{0.1}Mn_{0.1}O₂), a solid electrolyte (Li₆PS₅Cl_{0.5}Br_{0.5}), and a binder (VGCF) which were mixed with each other at a ratio of 70:30:3 were put into a mold and compressed at 200 MPa, thereby forming the cathode active material layer on one surface the solid electrolyte layer formed in 1).

### 3) Forming of Sacrificial Cathode Layer

0.1 g of red P (Sigma Aldrich) serving as a phosphorous precursor and 0.025 g of SC65 (TIMCAL) as a conductive material were introduced into a reactor, and a high energy ball milling (HEBM) process was performed with respect to the result at 300 RPM for 20 hours to manufacture red P-SC65 composite powders. 1.61 g of lithium biphenyl (Sigma Aldrich) dissolved in THE solution was added to the prepared red P-SC65 composite powders to prepare Li₃P-SC65 composite powders. The prepared Li₃P-SC65 composite powders were fired at 600° C. for 4 hours to prepare crystallized Li₃P-SC65 composite powders. Thereafter, 1.68 mg of the crystallized Li₃P-SC65 composite powders, 0.67 mg of the solid electrolyte (Li₆PS₅Cl_{0.5}Br_{0.5}) powders, and 0.04 mg of the binder (NBR) powders were matched against one surface of the cathode active material layer formed in 2) and compressed at 380 MPa to form the sacrificial cathode layer.

### 4) Manufacturing of Anode

The Li metal foil punched at 9 pi was matched against an opposite surface of the solid electrolyte layer formed in 1) and compressed at 380 MPa.

### Reference Example 3

### 1) Forming of Solid Electrolyte Layer

90 mg of solid electrolyte powders including Li₆PS₅Cl_{0.5}Br_{0.5} was put into a mold having an inner diameter of 10 mm, and compressed at 200 MPa, thereby forming the solid electrolyte layer.

### 2) Forming of Sacrificial Cathode Layer

0.1 g of red P (Sigma Aldrich) serving as a phosphorous precursor and 0.025 g of SC65 (TIMCAL) as a conductive material were introduced into a reactor, and a high energy ball milling (HEBM) process was performed with respect to the result at 300 RPM for 20 hours to prepare red P-SC65 composite powders. 1.61 g of lithium biphenyl (Sigma Aldrich) dissolved in THE solution was added to the prepared red P-SC65 composite powders to prepare Li₃P-SC65 composite powders. The prepared Li₃P-SC65 composite powders were fired at 600° C. for 4 hours to prepare crystallized Li₃P-SC65 composite powders. Thereafter, 1.68 mg of the crystallized Li₃P-SC65 composite powders, 0.67 mg of the solid electrolyte (Li₆PS₅Cl_{0.5}Br_{0.5}) powders, and 0.04 mg of the binder (NBR) powders were matched against one surface of the solid electrolyte layer formed in 2) and pressed at 380 MPa to form the sacrificial cathode layer.

### 3) Manufacturing of Anode

The Li metal foil punched at 9 pi was matched against an opposite surface of the solid electrolyte layer formed in 1) and compressed at 380 MPa.

### Experimental Example 1: Evaluation for Deterioration by Sacrificial Cathode Layer

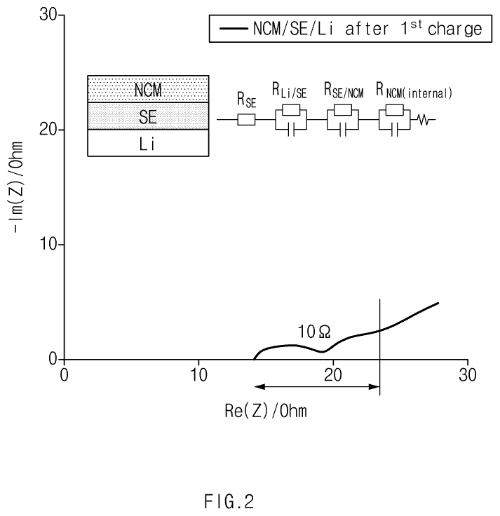

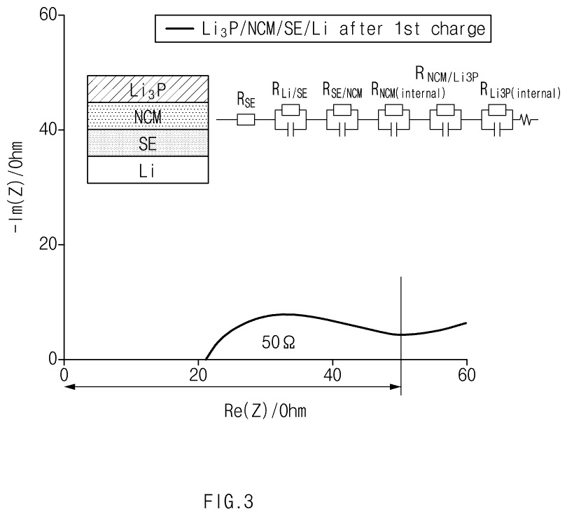

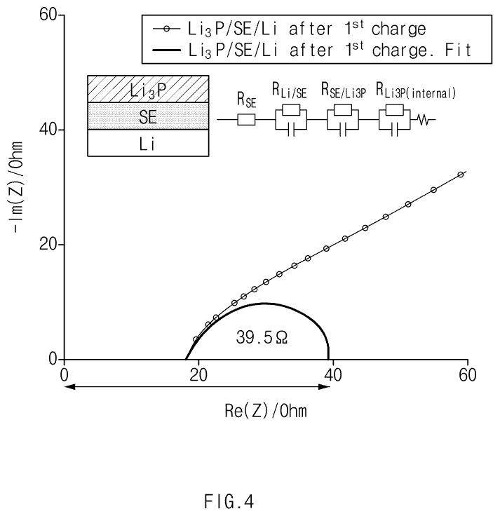

The resistance of the half-cell, which was obtained in each of Reference example 1 to Reference example 3, was measured through Electrochemical Impedance Spectroscopy (EIS) after an initial charging process, and the results are shown in Table 1 and FIGS. 2 to 4.

TABLE 1

| Reference | Reference | Reference |
|---|---|---|
| example 1 | example 2 | example 3 |
| R¹ = 10Ω | R² = 50Ω | R³ = 39.5Ω |

In Table 1, R¹ refers to a resistance, except for the resistance of the solid electrolyte in a half-cell (anode/solid electrolyte layer/cathode active material layer) having no sacrificial cathode layer, R² refers to a resistance of a half-cell (anode/solid electrolyte layer/cathode active material layer/sacrificial cathode layer) having a sacrificial cathode layer, and R³ refers to a resistance of a half-cell (anode/solid electrolyte layer/sacrificial cathode layer) having only a sacrificial cathode layer. In this case, R¹ to R³ may be expressed as follows.

$${R}^{1} = {R}_{Li / SE} + {R}_{SE / NCM} + {R}_{NCM ( internal resistance )}$$

$${R}^{2} = {R}_{Li / SE} + {R}_{SE} + {R}_{SE / NCM} + {R}_{NCM ( internal resistancce )} + {R}_{NCM / Li 3 P} + {R}_{Li 3 P ( internal resistance )}$$

$${R}^{3} = {R}_{Li / SE} + {R}_{SE} + {R}_{SE / Li 3 P} + {R}_{Li 3 P ( internal resistance )}$$

In the above equations, R_{Li/SE} refers to an interfacial resistor between the cathode (Li) and the solid electrolyte layer (SE), R_{SE/NCM} refers to an interfacial resistor between the solid electrolyte layer (SE) and a cathode active material layer (NCM), R_{NCM(internal resistor)} refers to an internal resistor of the cathode active material layer (NCM), R_{SE} refers to an internal resistor of to the solid electrolyte layer (SE), R_{NCM/Li3P} refers to an interfacial resistor between the cathode active material layer (NCM) and the sacrificial cathode layer (Li₃P), and R_{Li3P(internal)} refers to an internal resistor of the sacrificial cathode layer (Li₃P), and R_{SE/Li3P} refers to an interfacial resistor between the solid electrolyte layer (SE) and the sacrificial cathode layer (Li₃P).

In such embodiments, regarding R_{NCM/Li3P}, a resistor, which is between the cathode active material forming the cathode active material layer and the sacrificial active material forming the sacrificial cathode layer, is determined as a main resistor, and the cathode active material and the sacrificial active material are mixed with the solid electrolyte. Accordingly, R_{NCM/Li3P} may be determined as a resistor between the solid electrolyte and the solid electrolyte. In addition, regarding R_{SE/Li3P}, a resistor, which is between the solid electrolyte forming the solid electrolyte layer and the sacrificial active material forming the sacrificial cathode layer, is determined as a main resistor, and the sacrificial active material is mixed with the solid electrolyte as described above. Accordingly, R_{SE/Li3P} may be determined as a resistor between the solid electrolyte and the solid electrolyte. Accordingly, R_{NCM/Li3P} and R_{SE/Li3P}, which are resistors between the solid electrolyte and the solid electrolyte, are substantially similar to each other. Accordingly, on the assumption that R_{NCM/Li3P} is equal to R_{SE/Li3P}, R²−R³=R_{SE/NCM}+R_{NCM(internal resistor)}=10.5Ω. In the equation, the calculated value indicates the cathode interfacial resistor and the internal resistor when the sacrificial cathode layer is applied.

In some embodiments, R¹=R_{Li/SE}+R_{SE/NCM}+R_{NCM(internal resistor)}=10Ω. In this case, when a battery operates at 30 MPa, the anode and the solid electrolyte layer are strongly bonded to each other, so the interfacial resistor between the anode and the solid electrolyte layer is negligible. Accordingly, R¹≈R_{SE/NCM}+R_{NCM(internal resistor)}=10Ω. In the equation, the calculated value indicates the cathode interfacial resistor and the internal resistor when the sacrificial cathode layer is not applied.

In such embodiments, R_{SE/NCM}+R_{NCM(internal resistor)}=10.5Ω when the sacrificial cathode layer is applied, and R_{SE/NCM}+R_{NCM(internal resistor)}=10Ω when the sacrificial cathode layer is not applied. Accordingly, the two cases may be determined as showing similar resistances. Accordingly, it may be determined that the sacrificial cathode layer does not cause a meaningful deterioration phenomenon on the cathode interface of the all solid state battery and at the inside of the all solid state battery, after the charging process.

### Experimental Example 2: Measurement of Physical Property of Sacrificial Cathode Layer

### <Observation of Structure of Sacrificial Cathode Layer>

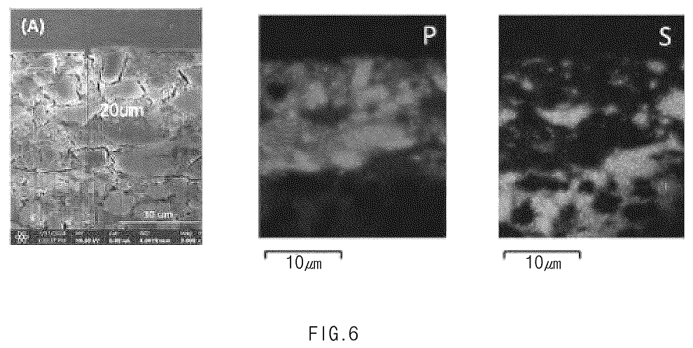

To analyze the cross-section of the all solid state battery manufactured in Example 1, after the cross-section of the all solid state battery was pretreated using a Helios Nanolab 450 hp double beam scanning electron microscope-focusing ion beam (SEM-FIB), the cross-section was observed through TEM, and the result is illustrated in FIG. 5. In addition, to analyze the cross-section through Energy-dispersive X-ray spectroscopy (EDX), the distribution of a P element and an S element was observed, and the observation result is illustrated in FIG. 5.

Referring to FIG. 5, the presence of Li₃P included in the sacrificial cathode layer may be recognized through a P mapping image measured through the EDX. Accordingly, it may be recognized that the thickness of the sacrificial cathode layer measured in Example 1 is 20 μm. In addition, it may be recognized that the solid electrolyte was mixed in the sacrificial cathode layer through the S mapping image measured through the EDX.

### <Measurement of Charging Capacity Sacrificial Cathode Layer>

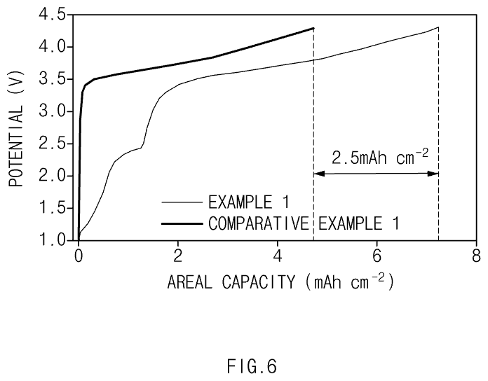

FIG. 6 illustrates the graph representing the relation between a voltage and an areal capacity, as the all solid state batteries manufactured in Example 1 and Comparative example 1 are pre-charged at the current density of 0.1 mA/cm² to be 4.3 V, under the condition of 30° C. and 30 MPa.

Referring to FIG. 6, it may be recognized that areal capacity was increased by 2.5 mAh/cm² in Example 1 including the sacrificial cathode layer, when compared to Comparative example 1 having no the sacrificial cathode layer. In addition, as observed in FIG. 5, it may be recognized that the areal capacity of 1.25 mAh/cm² was additionally realized per 10 [symbol] of the sacrificial cathode layer because the thickness of the sacrificial cathode layer according to Example 1 was 20 [symbol] .

### Experimental Example 3: Calculation of Average Crystal Size (XRD Analysis)

X-ray diffraction (XRD) was performed on the crystallized Li₃P-SC65 composite powders used in Example 1, and the average crystal size of Li₃P (sacrificial active material) was calculated through the following Equation 1.

$${D}_{p} = \frac{0.94 \times λ}{β \times Cos θ} \qquad Equation 1$$

wherein, in Equation 1,
Dp is the average crystal size of the sacrificial active material,
λ is a wavelength of an X ray used in an XRD analysis of the sacrificial active material,
θ is a Bragg angle of a main peak observed in the XRD analysis of the sacrificial active material, and
β is a full width at half maximum (FWMH) of a main peak observed in the XRD analysis of the sacrificial active material.

The average crystal size of Li₃P (sacrificial active material) according to Example 1 calculated through Equation 1 was 44.62 nm.

### Experimental Example 4: Measurement of Battery Characteristic

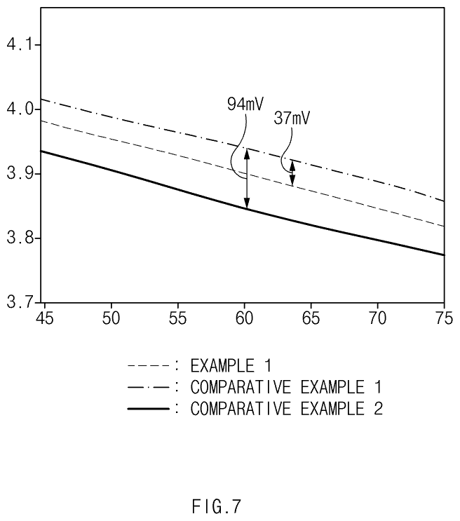

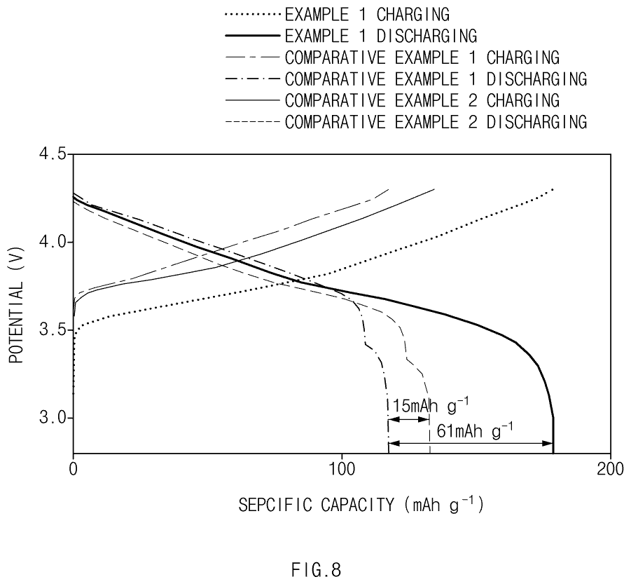

FIGS. 7 and 8 illustrate the graph representing the relation between a voltage and an areal capacity measured, as the all solid state batteries manufactured in Example 1 and Comparative examples 1 and 2 are charged at the current density of 0.5 mA/cm² to be 4.3 V, under the condition of 30° C. and 30 MPa, and discharged at the current density of 0.5 mA/cm² to be 3V.

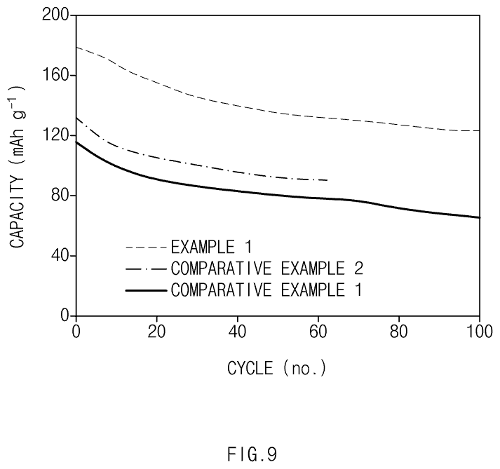

In addition, on the assumption that one cycle is defined as a period in which the all solid state batteries manufactured in Example 1 and Comparative examples 1 and 2 are charged at the current density of 0.5 mA/cm² to be 4.3 V, and discharged at the current density of 0.5 mA/cm² to be 3 V, under the condition of 30° C. and 30 MPa, the charging and discharging operation was repeated to 100th cycle, and a graph representing a specific capacity measured for each cycle is illustrated in FIG. 9.

FIG. 7 is a view obtained by enlarging a portion of a graph representing the relationship between a voltage and a specific capacity measured when each of the all solid state batteries of Example 1 of the present disclosure, and Comparative examples 1 and 2 is discharged. Referring to FIG. 7, cathode discharge overpotential of 38 mV was recognized in Example 1 employing the sacrificial cathode material as a separate layer, when compared to Comparative example 1 having no sacrificial cathode r material. In addition, cathode discharge overpotential of 94 mV was recognized in Comparative example 2 employing the sacrificial cathode material as an additive for the cathode active material layer, when compared to Comparative example 1 having no sacrificial cathode material. Accordingly, it may be recognized that the increase of the cathode discharge overpotential was suppressed in the all solid state battery according to Example 1, when compared to the all solid state battery according to Comparative example 2. This is likely because an air gap and a resistor are less formed due to the decomposition reaction of the sacrificial active material, as the sacrificial cathode material is applied to the all solid state battery according to Example 1, as a separate layer.

FIG. 8 is a graph representing the relation between a voltage and a specific capacity of each of all solid state batteries in Example 1 of the present disclosure, Comparative example 1, and Comparative example 2. Referring to FIG. 8, it may be recognized that a discharge capacity at an initial stage was improved by 61 mAh/g in Example 1, when compared to Comparative example 1, and that a discharge capacity at the initial stage was improved by 15 mAh/g in Comparative example 2, when compared to Comparative example 1. Accordingly, it may be recognized that the discharge capacity at the initial stage was increased when the sacrificial cathode material was present as the separate layer, relative to when the sacrificial cathode material was introduced into the cathode active material layer.

FIG. 9 is a graph representing a specific capacity measured for each cycle of each of all solid state batteries manufactured in Example 1 and Comparative examples 1 and 2. Referring to FIG. 9, it may be recognized, based on the 100^{th} cycle, that the all solid state battery according to Example 1 exhibited the best discharge capacity. Meanwhile, for Comparative example 2, as the air gap was formed in the anode active material layer due to the decomposition of the sacrificial active material, the experiment failed to proceed to the 100^{th} cycle.

According to an example of the present disclosure, the all solid state battery includes the separate layer including the sacrificial cathode material, rather than that the sacrificial cathode material is included in the cathode active material layer while serving as the additive. Accordingly, the side reaction resulting from the decomposition of the sacrificial cathode material may be suppressed, and the sacrificial cathode material may be added in an amount sufficient to compensate for this irreversible problem.

According to an example of the present disclosure, in the method for manufacturing the all solid state battery, the all solid state battery may be manufactured to suppress the side reaction resulting from the decomposition of the sacrificial cathode material, and may add the sacrificial cathode material in an amount sufficient to compensate for the irreversible problem.

Hereinabove, although the present disclosure has been described with reference to exemplary examples and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An all solid state battery comprising:
a cathode current collector;
a cathode active material layer disposed on the cathode current collector, and including a cathode active material;
a solid electrolyte layer disposed on the cathode active material layer;
an anode disposed on the solid electrolyte layer; and
a sacrificial cathode layer including a sacrificial active material, and disposed between the cathode current collector and the cathode active material layer.

2. The all solid state battery of claim 1, wherein the sacrificial active material is included in an amount ranging from 5 wt % to 20 wt, based on a total weight of the cathode active material included in the cathode active material layer.

3. The all solid state battery of claim 1, wherein the sacrificial cathode layer has ion conductivity ranging from 7.5×10⁻⁶ S/cm to 7.5×10⁻⁴ S/cm.

4. The all solid state battery of claim 1, wherein the sacrificial cathode layer has electron conductivity ranging from 9.6×10⁻⁶ S/cm to 9.6×10⁻³ S/cm.

5. The all solid state battery of claim 1, wherein the sacrificial cathode layer has a charging capacity ranging from 800 mAh/g to 1,200 mAh/g.

6. The all solid state battery of claim 1, wherein the sacrificial active material has oxidation-reduction potential lower than a discharge voltage of the cathode active material.

7. The all solid state battery of claim 1, wherein the sacrificial cathode layer further includes a conductive material, a solid electrolyte, and a binder, and
wherein, based on a total weight of the sacrificial cathode layer,
the sacrificial active material is included in an amount ranging from 50 wt % to 70 wt %,
the conductive material is included in an amount ranging from 5 wt % to 15 wt %,
the solid electrolyte is included in an amount ranging from 20 wt % to 35 wt %, and
the binder is included in an amount ranging from 0.5 wt % to 5 wt %.

8. The all solid state battery of claim 7, wherein the conductive material included in the sacrificial cathode layer is a carbon-based material.

9. The all solid state battery of claim 1, wherein the sacrificial cathode layer has a thickness ranging from 5 [symbol] to 40 [symbol] .

10. The all solid state battery of claim 1, wherein an average crystal size of the sacrificial active material calculated through Following Equation 1 ranges from 40 nm to 50 nm, and
$${D}_{p} = \frac{0.94 \times λ}{β \times Cos θ} \qquad Equation 1$$
wherein, in Equation 1,
Dp is an average crystal size of the sacrificial active material,
λ is a wavelength of an X ray used in XRD analysis of the sacrificial active material,
θ is a Bragg angle of a main peak observed in the XRD analysis of the sacrificial active material, and
β is a full width at half maximum (FWMH) of a main peak observed in the XRD analysis of the sacrificial active material.

11. The all solid state battery of claim 1, wherein the solid electrolyte layer includes a sulfide-based solid electrolyte.

12. The all solid state battery of claim 1, wherein the anode includes:
an intermediate layer disposed on the solid electrolyte layer; and
an anode current collector disposed on the intermediate layer.

13. The all solid state battery of claim 12, wherein the anode current collector includes at least one of nickel (Ni), copper (Cu), stainless steel (SUS), silver (Ag), and a combination of nickel (Ni), copper (Cu), stainless steel (SUS), or silver (Ag).

14. The all solid state battery of claim 13, wherein the intermediate layer includes metal particles for forming an alloy with lithium.

15. The all solid state battery of claim 14, wherein the metal particles comprise one or more of: beryllium (Be), magnesium (Mg), aluminum (Al), silicon (Si), calcium (Ca), scandium (Sc), chromium (Cr), manganese (Mn), iron (Fe), cobalt (Co), nickel (Ni), copper (Cu), zinc (Zn), gallium (Ga), germanium (Ge), arsenic (As), strontium (Sr), yttrium (Y), zirconium (Zr), niobium (Nb), molybdenum (Mo), technetium (Tc), rhodium (Rh), palladium (Pd), silver (Ag), cadmium (Cd), indium (In), tin (Sn), antimon (Sb), tellurium (Te), barium (Ba), hafnium (Hf), tantalum (Ta), tungsten (W), rhenium (Re), iridium (Ir), platinum (Pt), gold (Au), mercury (Hg), thallium (TI), phosphorus (Pb), or bismuth (Bi), and/or a combination thereof.
